(19) United States
(12) Patent Application Publication
(10) Pub. No.: US 2007/0243004 A1
(43) Pub. Date: Oct. 18, 2007

(54) System, device, and paper for printing an image

(75) Inventor: Naoki Kuwasaki, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/786,069

(22) Filed: Apr. 10, 2007

(30) Foreign Application Priority Data
Apr. 14, 2006 (JP) 2006-112085

(51) Int. Cl. B41J 29/00

(52) U.S. Cl. 400/708

(57) ABSTRACT

A system and a device for printing an image, and a paper for printing an image thereon, which help reduce a printing mistake, thereby minimize waste of high-priced papers. The system includes a print instruction unit, a paper, a detection unit, a print determination unit, and a print unit. The device includes a detection unit, a print determination unit, and a print unit. The paper is configured to record paper type data in advance. The detection unit detects the paper type data from the paper. The print instruction unit transmits paper specific data and instructs the print device to perform printing through a network. Only if the paper specific data and the detected data correspond to each other, the print determination unit outputs print permission data. Based on the permission data, the print unit prints an image onto one of the unprinted paper.

### FIELD OF THE INVENTION

The present invention relates to a system and a device for printing an image and papers for printing an image thereon, more specifically, to the system and the device for printing an image, and the paper used for the device, all of which function optimally when used for printing stock certificates, gift certificates, tickets, and the like.

### BACKGROUND OF THE INVENTION

Japanese Patent Laid-Open No. 2002-342519 discloses a method of printing a certain image on a paper with money value, such as a stock certificate, a gift certificate, and a ticket.

The disclosed method is intended to protect papers used as performance tickets and certificates from duplicate registration of and other unauthorized use. ID data included in an IC (Integrated Circuit) chip embedded on a ticket, a certificate, and other papers with money value is read with a reading terminal. An ID data management center verifies nonuse of the paper when inquired through Internet. If verified, the ID data management center transmits the required image data to the reading terminal. The reading terminal is configured to print certain image data on the IC-chipped paper.

However, such configuration still can not solve problems. The method allows the ID data management center to manage a performance ticket and a certificate to protect them from duplicate registration and illegal copies, yet it does not control execution of printing at the terminal. Any user can print image data on the IC-chipped papers.

More specifically, a paper can be selected without a restriction upon printing, so that an IC-chipped paper can also be selected for printing. Whether printing a performance ticket, a certificate, and others, when it is printed at the user terminal of a PC (Personal Computer) and the like, the print job can be executed without verifying with the ID data management center.

Therefore, a printing mistake can occur by selecting a wrong paper type when IC-chipped papers are set in each paper input tray.

Since the papers used for stock certificates, gift certificates, and the like are generally of high quality and price, it is essential to develop a method to prevent generation of a printing mistake in order to keep the cost down.

### SUMMARY OF THE INVENTION

The present invention is made to address such issues by providing a system and a device for printing an image, and papers for printing an image thereon, which help minimize generation of a printing mistake in printing an image onto them to prevent waste of high-priced papers.

In order to address abovementioned issues, the system of the present invention for printing an image includes a print instruction unit, a paper, a detection unit, a print determination unit, and a print unit. The print instruction unit transmits paper specific data and instructs an execution of a print job through a network. The paper used for printing an image thereon includes paper type data of the paper itself. The detection unit detects the paper type data from the paper. The print determination unit outputs print permission data if the detected data matches the paper specific data acquired through the network. The print unit prints a certain image onto the paper, based on the print permission data.

Alternatively, in the system of the present invention for printing an image, the print instruction unit can be configured to transmit paper specific data along with the image.

The device of the present invention for printing an image includes a detection unit, a print determination unit, and a print unit. The paper used for printing an image thereon includes paper type data of the paper itself. The detection unit detects the paper type data from the paper. The print determination unit outputs print permission data if the detected data matches the paper specific data acquired through the network. The print unit prints a certain image onto the paper, based on the print permission data.

Furthermore, the system and the device for printing an image can be configured to install the detection unit on a paper cassette into which a stack of papers are inserted. The paper cassette is placed on a paper transfer path for guiding a paper to the print unit.

Alternatively, the system and the device for printing an image can be configured for the detection unit to detect the paper type data from an RFID (Radio Frequency Identification) chip attached to the paper, which stores the data.

Yet alternatively, the system and the device for printing an image can also be configured to install a record unit for recording copy permission data on the RFID chip.

Yet alternatively, the system for printing an image can be also configured to involve the following steps. A password is recorded on the paper in advance. The print instruction unit transmits a password same as the password recorded on the paper. The detection unit detects the password from the paper. If the password transmitted from the print instruction unit and the one detected by the detection unit match, the print determination unit will output the print permission data.

Furthermore, a configuration of the device of the present invention for printing an image can be such that the detection unit detects the password having been recorded on the paper and if the password configured in advance corresponds to the password detected by the detection unit, the print determination unit outputs the print permission data.

Yet furthermore, the paper for printing an image thereon can record the paper type data in advance.

Alternatively, the paper for printing an image thereon can also be designed to store the paper type data in advance in the RFID chip attached to a main body of the paper.

The system of the present invention for printing an image prevents a printing mistake to save a high-quality and -priced paper and also enables a remote printing through the network. In the system, each unit performs the following steps. The print instruction unit transmits the paper specific data through the network. The detection unit detects the paper type data from the paper. If the detected data matches the paper specific data acquired through the network, the print determination unit outputs the print permission data. The print unit prints a certain image onto the paper based on the print permission data.

Furthermore, the system for printing an image, which includes the print instruction unit configured to transmit the paper type data along with the image, can perform printing according to a type of the paper and printing content.

Yet furthermore, the device of the present invention for printing an image contributes to minimize generation of a printing mistake, thereby to prevent waste of a high-priced paper. The detection unit detects the paper type data from the paper on which the data is recorded. The print determination unit outputs the print permission data if the detected data corresponds to given paper specific data. The print unit prints an image onto the paper, based on the print permission data.

Yet furthermore, in the system and the device for printing an image with the detection unit installed on the paper cassette placed on the paper transfer path for guiding a paper to the print unit, the paper type data can be detected simply by inserting a piece of the paper into the paper cassette. Additionally, the system does not allow the paper cassette to transfer any of the papers when not printing, so that a printing mistake can be prevented.

Yet furthermore, in the system and the device for printing an image, which detects paper type data at the detection unit from the RFID chip attached to the paper, a human eye cannot read paper types.

Yet furthermore, the system and the device for printing an image with the record unit for recording the copy permission data installed on the RFID chip can restrict copying of the paper that have already been printed an image thereon.

Additionally, the system of the present invention for printing an image enables authentication of the user who executes a print job, in addition to prevention of a printing mistake on the paper, if the print determination unit is configured to output the print permission data if the password transmitted by print instruction unit and the one detected by the detection unit are the same.

Furthermore, the device of the present invention for printing an image enables authentication of the user who executes a print job, in addition to prevention of a printing mistake on the paper, if the print determination unit is configured to output the print permission data if the password on the paper, which has been configured in advance, matches the one detected by the detection unit.

Yet furthermore, since the paper for printing an image thereon records the paper specific data, the abovementioned effects can be better achieved.

Yet furthermore, the paper for printing an image thereon can improve security since the configuration is such that the RFID chip attached to the paper stores the paper type data in advance and that the paper type data cannot be decoded by anyone with his or her eyes.

These and other objects, features and advantages of the present invention are specifically set forth in or will become apparent from the following detailed descriptions of the invention when read in conjunction with the accompanying drawings.

### DESCRIPTION OF THE DRAWINGS

FIG. 1 is a block diagram illustrating a preferred embodiment of the system of the present invention for printing an image along with an image print device.

FIG. 2 is a diagram illustrating an example of the paper of the present invention for printing an image thereon.

FIG. 3 is a sequence diagram indicating an operation of in the system of the present invention for printing an image.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

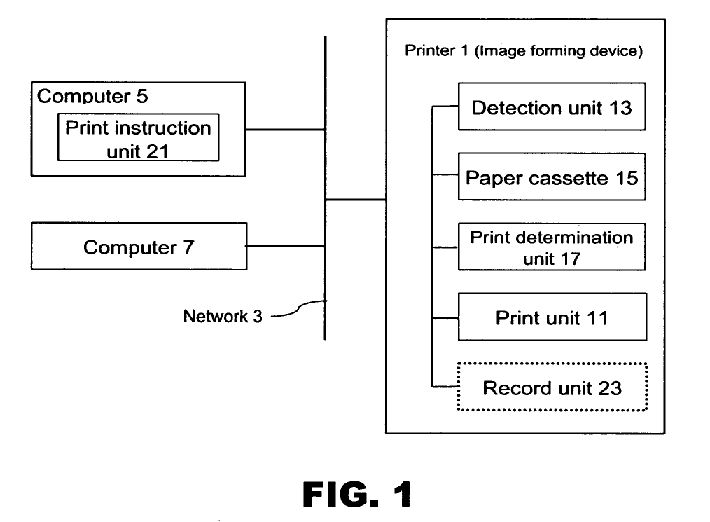

FIG. 1 is a block diagram illustrating a preferred embodiment of the system of the present invention for printing an image along with an image print device.

In FIG. 1, a printer 1 is an image print device having functions to be described hereinafter, and connected with computers 5 and 7 through a network 3. The both computers 5 and 7 include a printer driver for controlling the printer I in printing and the other elements that are the same. Therefore, only the computer 5 will be described here in order to avoid redundancy.

The printer 1 has a print unit 11 for printing an image on a paper 9, a detection unit 13 for detecting a type of the paper 9, a paper cassette 15 into which the paper 9 is inserted, and a print determination unit 17 for determining whether or not the image can be printed on the paper 9. Details will be described hereinafter.

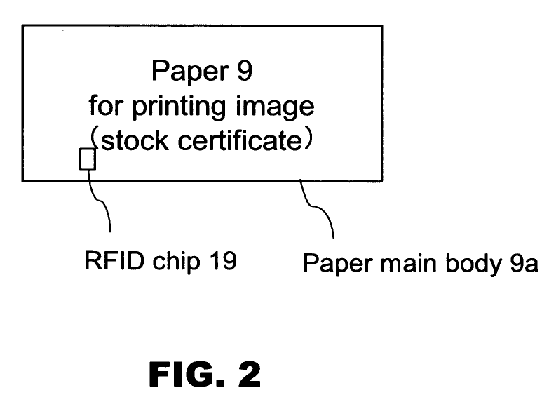

The paper 9 is a high-priced paper such as a stock certificate, a gift certificate, and the like. Therefore, a printing mistake is desirable to be prevented as possible. As shown in FIG. 2, the paper 9 includes a paper main body 9a and an RFID chip 19 attached to the paper main body 9a.

The RFID chip 19 is an extremely small semiconductor chip, such as a one-millimeter-square semiconductor chip embedded in the paper main body 9a or attached to the surface thereof, and stores in advance the following data in a read-and-write manner.

The RFID chip 19 stores an RFID chip ID data, country data, paper specific data, sequential issuance number, copy permission data, and others. The RFID chip ID data is constituted of symbol codes for identifying the individual RFID chip 19. The country data indicates a creator of the RFID chip 19 and the country where the RFID chip 19 is issued. The paper type data specifies a type of documents, such as a stock certificate and a gift certificate, for the RFID chip 19 to be attached to. The sequential issuance number helps the issuer to manage the issued papers. The copy permission data allows or prohibits copying of the paper 9 to which the RFID chip 19 attached. In other words, the RFID chip 19 is a microchip which stores the abovementioned various types of data as 32-bit or 64-bit electronic data.

The detection unit 13 is placed on the paper cassette 15 which is installed on the printer 1 in a detachable manner. The paper 9 is to be inserted into the paper cassette 15. The detection unit 13 is a sensor which reads the paper type data from the RFID chip 19 on the paper 9. As described hereinafter, the detection unit 13 sends a weak electromagnetic wave to the RFID chip 19, receives the electromagnetic wave from the RFID chip 19, reads the paper type data stored in advance in the RFID chip 19 in a non-direct-contact manner, and outputs the data to the print determination unit 17.

The print determination unit 17 outputs the print permission data to the print unit 11 if the paper specific data having been acquired in advance from the computer 5 through the network 3 and the paper type data detected by the detection unit 13 matches.

The print unit 11 is a monochrome or color print unit which prints a print image in the process of extracting the paper 9 from the paper cassette 15 and transferring it to the print unit 11. The print unit 11 includes conventional units (not shown), such as a paper transfer roller for transferring the paper 9, a photo-sensor unit, an image-transfer unit, and an adhesive unit.

The computer 5 has a print instruction unit 21. The print instruction unit 21 forms an image to be printed onto the paper 9 such as a layout of a stock certificate, and conventional items of a print image of this kind such as price and an issuer. Additionally, the print instruction unit 21 pairs the paper specific data specifying a stock certificate onto which the print image to be printed with the print image, and outputs the print image and the paper specific data to the printer 1 through the network 3 and instructs the printer 1 to print the image.

The relationship between the paper specific data transmitted from the computer 5 and the paper type data stored in the RFID chip 19 on the paper 9 is that either the paper specific data is created according to the paper type data stored in the RFID chip 19, or the paper type data matching the paper specific data transmitted from the computer 5 is stored into the RFID chip 19.

The print determination unit 17 and other units can be configured with a microcomputer for controlling printing, which has a CPU (Central Processing Unit), a ROM (Read-Only-Memory), a RAM (Random Access Memory), and an I/O (Input/Output) interface. The CPU performs all the instruction, logic, and mathematical processing in the computer 5, and is responsible for controlling the printer 1. The ROM stores an operation program of the CPU. The RAM temporality stores the paper specific data, the paper type data, the print permission data, and other data.

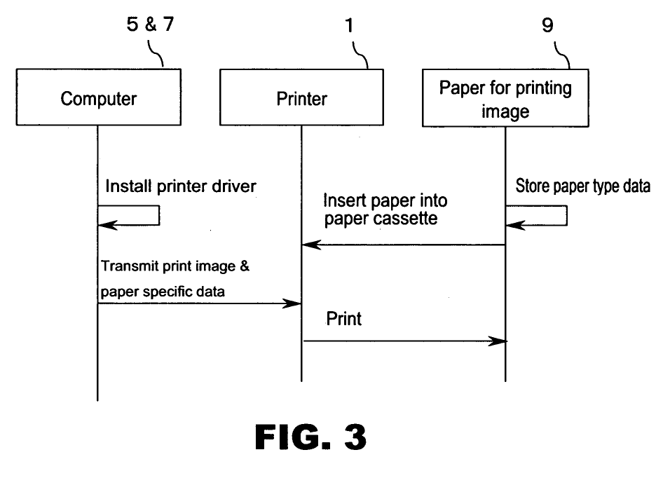

The following briefly describes operation in the system for printing an image in reference to FIG. 3.

First, the computer 5 is installed with a printer driver in advance.

Insert a stack of the paper (unprinted stock certificate) 9 into the paper cassette 15 of the printer 1. The paper 9 is attached with the RFID chip 19, which stores the paper type data to indicate that it is a stock certificate. The print instruction unit 21 of the computer 5 transmits the image to be printed and the paper specific data to the printer 1 through the network 3 and instructs the printer 1 to print out the image.

In response, the detection unit 13 of the printer 1 reads the paper type data from the RFID chip 19 on the paper (unprinted stock certificate) 9 to output it to the print determination unit 17.

The print determination unit 17 outputs the print permission data to the print unit 11 if the paper specific data acquired from the computer 5 through the network 3 in advance and the paper type data detected by the detection unit 13 corresponds to each other. Based on the print permission data, the print unit 11 extracts the paper (unprinted stock certificate) 9 from the paper cassette 15 and prints the image thereon while the paper 9 is being transferred through the transfer path to externally output the printed paper.

If the paper specific data and the paper type data do not match, the print determination unit 17 does not output the print permission data. Therefore, the print unit 11 will not operate so that the (unprinted stock certificate) paper 9 will not be extracted from the paper cassette 15 to be printed with the image.

As seen, the system for printing an image can reduce a printing mistake to save the high-priced paper (unprinted stock certificate) 9. The print instruction unit 21 of the computer 5 transmits the paper specific data and instructs the printer 1 to perform printing through the network 3. The paper 9 has the paper type data recorded thereon. The detection unit 13 detects the paper type data from the paper (unprinted stock certificate) 9. If the detected paper type data matches the paper specific data, the print determination unit 17 outputs the print permission data. Based on the print permission data, a certain image is printed on the paper (unprinted stock certificate) 9 at the print unit 11.

Accordingly, a type of the paper (unprinted stock certificate) 9 can be determined, and thus, a printing mistake can be minimized. Furthermore, printing operation over the paper (unprinted stock certificate) 9 can be restricted, and a print job can be remotely executed on only a specific paper through the network 3.

Yet furthermore, since the system will be configured to transmit the print image along with the paper specific data from the print instruction unit 21, a print job can be remotely executed according to a type of the paper and print content.

Yet furthermore, the system enables detection of the paper type data before extracting the paper (unprinted stock certificate) 9 from the paper cassette 15 by installing the detection unit 13 on the paper cassette 15. The paper cassette 15 is placed on the paper transfer path for guiding the paper (unprinted stock certificate) 9 to the print unit 11. The configuration allows detection of the paper type data simply by inserting the paper (unprinted stock certificate) 9 into the paper cassette 15. If the print job is not executed due to disagreement between the paper specific data and the paper type data, the paper 9 will not be transferred to the print unit 11, thereby a printing mistake can be prevented.

Additionally, since the paper type data is detected by the unit 13 from the RFID chip 19 attached to the paper main body 9a, the paper type data cannot be decoded just by looking at it. Therefore, the configuration is also effective for improving security in handling of the paper.

An optimal configuration of the present invention will be for the RFID chip 19 to store the paper type data to be attached to the paper 9. The paper type data can also be configured to be constituted of a barcode, a special print pattern, or any others, yet is ideal to be stored into the RFID chip 19 for security perspective.

Alternatively, the present invention can include more than one paper cassette 15 and multiple trays therein into which the paper 9 is inserted.

In the above configuration, the detection unit 13 is installed onto the each paper cassette 15. Each of the papers 9 is inserted into the individual paper cassette 15. The paper 9 is attached with the RFID chip 19 having stored the individual paper type data. If the print instruction unit 21 transmits the print image selected at the computer 5 and the paper specific data to be paired with the selected print image to the printer I through the network 3, the individual image can be printed on the corresponding paper 9 without a printing mistake.

Alternatively, the present invention can be configured to execute a print job if the print type data matches a paper specified by the paper specific data instead of executing it only if those data match each other. In other words, the present invention can be configured to be able to perform printing if elements of the print type data are included in the paper specific data.

Yet alternatively, the present invention, as shown in FIG. 1, can install a record unit 23 on the printer 1. The RFID chip 19 on the paper 9 inserted into the paper cassette 15 or on the paper 9 transferred to the print unit 11 for printing can record a certain piece of the copy permission data.

If the RFID chip 19 stores the copy permission data, when coping the paper 9 which has already been printed with the print image thereon, copying can be permitted or prohibited based on absence or presence of the copy permission data. Accordingly, an authorized copying can be effectively prevented and the security can be assured.

Yet alternatively, the system for printing an image also can be configured to incorporate a password to authorize a print job, in addition to the step of comparing the paper type data which indicates the type of the paper 9 and the paper specific data which specifies the paper to be used for printing.

More specifically, the configuration which incorporates a password is as follows. The RFID chip 19 on the paper 9 records a password in advance. The print instruction unit 21 of the computer 5 transmits a password same as the password recorded on the RFID chip 19. The detection unit 13 detects the password from the paper 9. If the password transmitted by the print instruction unit 21 and the one detected by the detection unit 13 matches, the print determination unit 17 outputs the print permission data.

Such configuration can not only prevent a printing mistake in printing on the paper 9, but also prohibit the user without the password to execute a print job by requiring the user authentication.

Next, the device of the present invention for printing an image will be briefly described.

The device of the present invention for printing an image is equivalent to the printer 1 in FIG. 1. The device includes the detection unit 13, the print determination unit 17, and the print unit 11. The paper 9 for printing an image thereon has the recorded paper type data. The detection unit 13 detects the paper type data from the paper 9. The print determination unit 17 outputs the print permission data if the detected paper type data corresponds with the paper specific data configured in advance. The print unit 11 prints a certain image onto the paper 9, based on the print permission data.

A device for printing an image of such configuration, too, can minimize generation of a printing mistake in printing an image onto the paper 9, and thus, to reduce waste of pricey papers.

Furthermore, the device of such configuration can also install the detection unit 13 on the paper cassette 15 placed on the paper transfer path for guiding the paper to the print unit 11. The detection unit 13 detects the paper type data from the RFID chip 19 attached to the paper main body 9a. The device can also install the record unit 23 for recording the copy permission data on the RFID chip 19. The above configuration also can bring the beneficial effects that can be achieved through the system of the present invention for printing an image.

Yet furthermore, the detection unit 13 of the device of the present invention for printing an image can detect the password stored in advance in the RFID chip 19. If the detected password matches the password configured in advance, the print determination unit 17 outputs the print permission data. This configuration can also result in the same effects achieved through the system of the present invention for printing an image.

The present document incorporates by reference the contents of Japanese priority document, Japanese Patent Application No. 2006-112085, filed in Japan on Apr. 14, 2006.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A system for printing an image, comprising:
a print instruction unit which transmits paper specific data and instructs printing through a network;
a paper for printing an image thereon, which records paper type data,
a detection unit which detects the paper type data from the paper;
a print determination unit which outputs print permission data if the paper specific data acquired through the network and the paper type data detected by the detection unit correspond; and
a print unit which prints an image onto the paper, base on the print permission data.

2. The system for printing an image of claim 1, wherein:
the print instruction unit transmits the paper specific data along with the image.

3. The system for printing an image of claim 1, further comprising:
a paper transfer path which guides the paper to the print unit;
a paper cassette which is placed on the paper transfer path, wherein:
the detection unit is installed on the paper cassette; and
the paper is inserted into the paper cassette.

4. The system for printing an image of claim 1, further comprising.
a RFID chip which stores the paper type data and which is attached to the paper, wherein:
the detection unit detects the paper type data from the RFID chip

5. The system for printing an image of claim 4, further comprising:
a record unit which records copy permission data on the RFID chip.

6. The system for printing an image of claim 1, wherein:
the paper records a password in advance;
the print instruction unit transmits a password same as the recorded password;
the detection unit detects the recorded password from the paper; and
the print determination unit outputs the print permission data if the password transmitted by the print instruction unit and the one detected by the detection unit correspond.

7. A device for printing an image, comprising:
a detection unit which detects from the paper the paper type data which has been recorded on the paper;
a print determination unit which outputs print permission data if paper specific data and the paper type data detected by the detection unit correspond; and
a print unit which prints an image onto the paper, base on the print permission data.

8. The device for printing an image of claim 7, further comprising:
a paper transfer path which guides the paper to the print unit;
a paper cassette which is placed on the paper transfer path, wherein:
the detection unit is installed on the paper cassette; and

9. The device for printing an image of claim 7, further comprising:
a RFID chip which stores the paper type data and which is attached to the paper, wherein:
the detection unit detects the paper type data from the RFID chip.

10. The device for printing an image of claim 9, comprising:
a record unit which records copy permission data on the RFID chip.

11. The device for printing an image of claim 1, wherein:
the detection unit detects from the paper a password recorded thereon in advance; and
the print determination unit outputs the print permission data if a password configured in advance and the one detected by the detection unit correspond.

12. A paper for printing an image thereon, comprising:
a RFID chip which stores paper type data; and
a paper main body which has the RFID chip.

13. The paper for printing an image of claim 12, wherein:
the paper type data is recorded in advance on the RFID chip attached to the paper main body.
